(19) United States
(12) Patent Application Publication
(10) Pub. No.: US 2011/0127119 A1
(43) Pub. Date: Jun. 2, 2011

(54) Ratchet mechanism for quickly adjusting tightness of brake cable in a caliper brake of bicycle

(76) Inventor: Szu-Fang Tsai, Changhua (TW)

(21) Appl. No.: 12/626,958

(22) Filed: Nov. 30, 2009

(51) Int. Cl. B62L 1/06

(52) U.S. Cl. 188/24.19

(57) ABSTRACT

A caliper brake of a bicycle includes a first arm; a cable housing disposed at one end of the first arm; a second arm pivotably secured to the first arm and comprising a yoke at one end, the yoke including two opposite yoke arms; a brake cable retaining member for retaining a brake cable passing the cable housing; a pawl pivotably disposed between the yoke arms and secured to the brake cable retaining member, the pawl including a tooth; and a spring depressible ratchet including a hook at one end, the ratchet being pivotably disposed between the yoke arms to have the hook to engage with the tooth so that the ratchet is held against rotation to hold the brake cable tight. Counterclockwise rotating the ratchet to disengage the hook from the tooth and clockwise rotating the pawl will loosen the brake cable.

### BACKGROUND OF THE INVENTION

1. Field of Invention

The invention relates to bicycle brake systems and more particularly to a ratchet mechanism for quickly adjusting tightness of a brake cable (i.e., loosening the brake cable) in a caliper brake of bicycle with improved characteristics.

2. Description of Related Art

A conventional caliper brake of bicycle is shown in FIG. 5. The caliper brake is implemented as a single pivot side-pull brake. In a normal condition, a brake cable 3 is held tight. It is seen that a distance between two opposite brake pads 13 and 14 is less than a width of a tire 4. The caliper brake comprises a brake cable loosening and tightening device 10 at one end of a second arm 120 which has a second brake pad 13 at the other end. The caliper brake further comprises a first arm 110 having a lower end provided with a first brake pad 14 opposite the second brake pad 13 and an upper end with a cable housing 11 provided thereat. Both arms 110, 120 cross at a pivot (not shown). A brake cable 3 passes the cable housing 11 to terminate at the brake cable loosening and tightening device 10. A fastener 2 has a nut 21 for fastening the brake cable 3 at the cable housing 11.

For removing the tire 4 for repair or replacement, a person may manipulate the brake cable loosening and tightening device 10 to loosen the brake cable 3. Hence, both brake pads 13, 14 move laterally away from each other. The manipulation of the brake cable loosening and tightening device 10 can be stopped if the distance between the brake pads 13 and 14 is greater than the width of the tire 4. Thereafter, the person may easily remove the tire 4.

But this is unsatisfactory for the purpose for which the invention is concerned for the following reasons:

The brake cable loosening and tightening device 10 is exposed. Hence, it tends to loosen or damage due to frequent contact with foreign objects. Further, its appearance is not aesthetic. Furthermore, its operation is not smooth or even uneasy. Thus, a need for improvement exists.

### SUMMARY OF THE INVENTION

It is therefore one object of the invention to provide a ratchet mechanism for quickly adjusting tightness of a brake cable in a caliper brake of bicycle.

The above and other objects, features and advantages of the invention will become apparent from the following detailed description taken with the accompanying drawings.

### BRIEF DESCRIPTION OF THE DRAWINGS

FIG. 1 is a perspective view of a caliper brake of bicycle incorporating a preferred embodiment of mechanism for quickly adjusting tightness of a brake cable according to the invention;

FIG. 2 is an exploded view of the mechanism of FIG. 1;

FIG. 3 is a schematic front view of the mechanism of FIG. 1, where the mechanism is in a normal condition with the brake cable being held tight;

FIG. 4 is a view similar to FIG. 3 where the mechanism has been manipulated to loosen the brake cable; and

FIG. 5 is a schematic front view of a conventional caliper brake of bicycle.

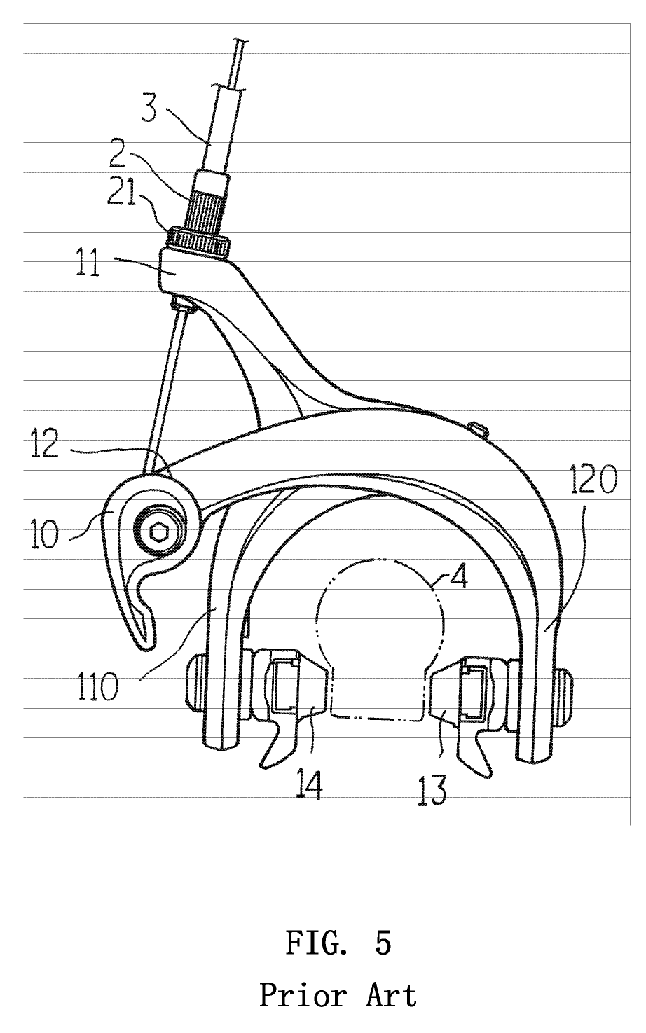

### DETAILED DESCRIPTION OF THE INVENTION

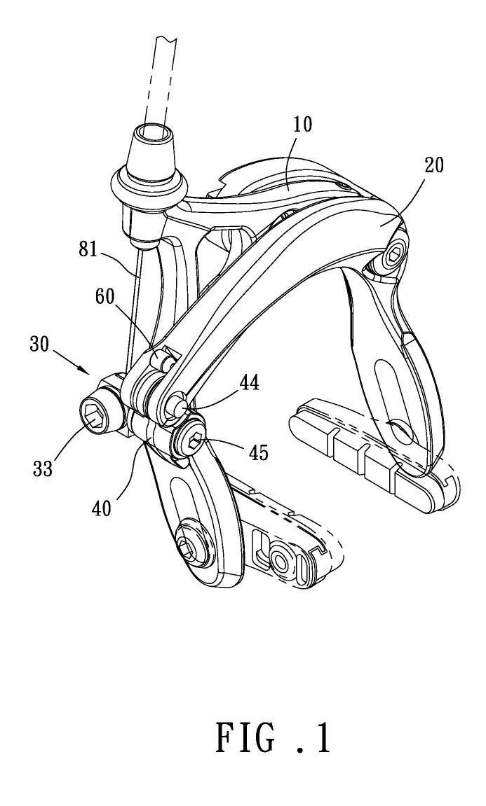

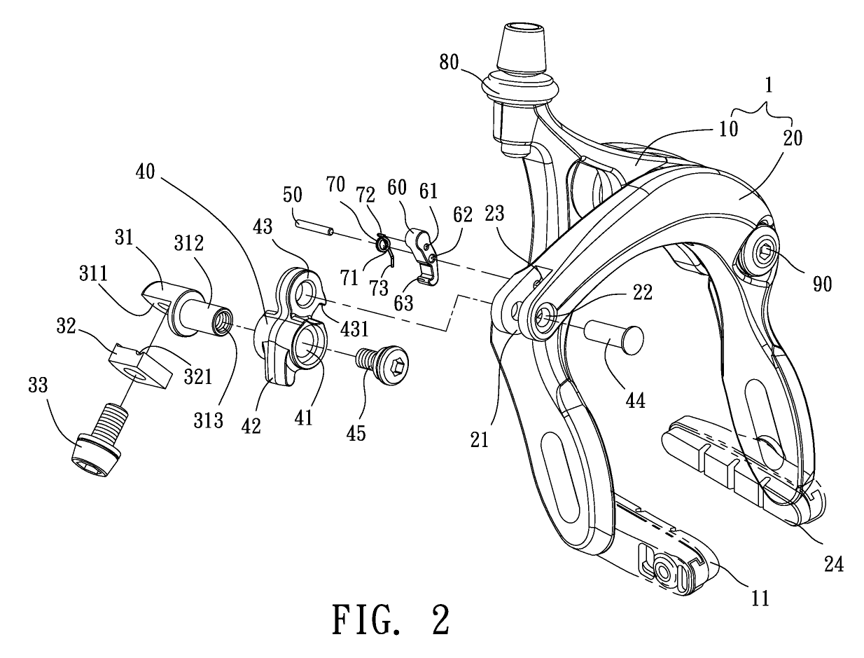

Referring to FIGS. 1 to 4, a caliper brake 1 of bicycle according to the invention is shown. The invention comprises the following components as discussed in detail below.

The caliper brake 1 is implemented as a single pivot side-pull brake. The caliper brake 1 comprises a mechanism (not numbered) provided at one end of a second arm 20 which has a second brake pad 24 at the other end. The caliper brake 1 further comprises a first arm 10 having a lower end provided with a first brake pad 11 opposite the second brake pad 24 and an upper end with a cable housing 80 provided thereat. Both arms 10, 20 cross at a pivot 90. A brake cable 81 passes through the cable housing 80 to terminate at the mechanism for quickly adjusting tightness of the brake cable 81. The mechanism will be discussed in detail later. In a normal condition, the brake cable 81 is held tight. One end of the second arm 20 is shaped as a yoke including two hole-shaped yoke arms 22, a space 21 between the yoke arms 21, and a pivot hole 23 through one of the yoke arms 22.

The mechanism as the subject of the invention comprises a brake cable retaining assembly 30, a pivotal paw 40 a pin 50, a ratchet 60, and a ratchet spring 70. Each component is discussed in detail below.

The brake cable retaining assembly 30 comprises a body 31 including a recessed flat 311 having a threaded hole (not numbered), a projecting cylindrical member 312 having internal threads 313; a rectangular clamping block 32 having a threaded hole 321; and a threaded fastener 33. The brake cable 81 passes through the threaded hole of the flat 311 to terminate at a joining surface of the flat 311 and the clamping block 32. The threaded fastener 33 is driven through the threaded hole 321 into the threaded hole of the flat 311 to fasten the brake cable 81.

The pivotal paw 40 comprises an intermediate through hole 41 with the cylindrical member 312 disposed therein, an extending lever 42 at one end, a holed hinged member 43 at the other end disposed in the space 21, the hinged member 43 including a V-shaped tooth 431, and a threaded fastener 45 (e.g., bolt) driven into the through hole 41 into the threads 313 to secure the paw 40 and the brake cable retaining assembly 30 together. Further, a pivot pin 44 is driven through one hole-shaped yoke arm 22 and the hole of the hinged member 43 into the other hole-shaped yoke arm 22 to pivotably secure pawl 40 and the second arm 20 together.

The ratchet 60 is hollow and elongated. The ratchet 60 comprises a hook 63 at one end, an intermediate through hole 62, and a hole 61 spaced from the through hole 41 and being in communication with the internal space of the ratchet 60. The ratchet spring 70 is a torsion spring and disposed in the hollow of the ratchet 60. The pin 50 is inserted through the pivot hole 23, one end of the through hole 62, the central hole of the ratchet spring 70, and the other end of the through hole 62 into a cavity (not shown) on the wall of the space 21 opposing the pivot hole 23. As a result, the ratchet 60 is pivotably disposed in the space 21 with its other end projecting out of the space 21 for ease of manipulation. The ratchet 60 is pivotably secured to the yoke arms 22 (i.e., the second arm 20).

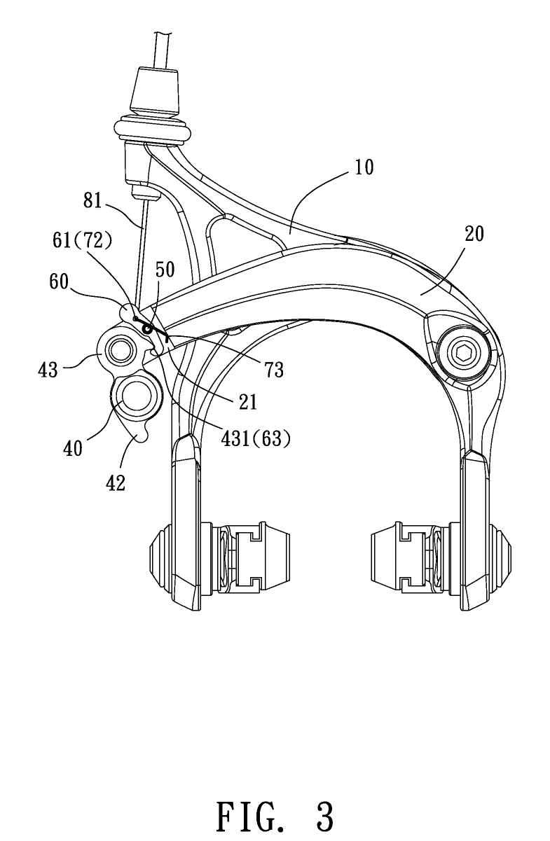

As shown in FIG. 3, at this fastened position one bent end 73 of the ratchet spring 70 is urged against a blind end of the space 31 proximate to the pivot hole 23 and the other end 72 thereof is anchored in the hole 61. Moreover, the tooth 431 is meshed with the recessed portion of the hook 63 to hold the ratchet 60 against rotation when so desired.

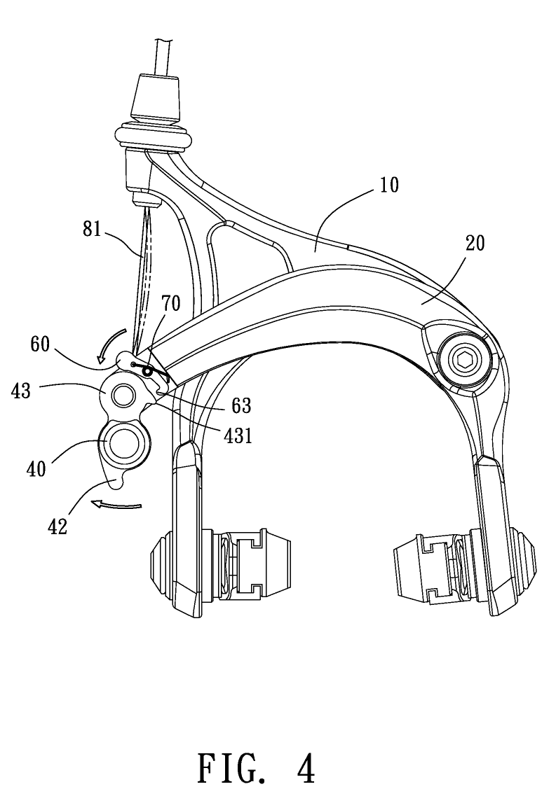

For quickly adjusting tightness of the brake cable 81, a person may manipulate the mechanism as follows (see FIG. 4). The person may counterclockwise pivot the upper end of the ratchet 60 to disengage the hook 63 of the ratchet 60 from the tooth 431 as indicated by an upper arrow. Next, the person may clockwise pivot the pawl 40 by holding and rotating the lever 42 as indicated by a lower arrow. As a result, the brake cable 81 is loosened (see dashes of the brake cable 81). For tightening the brake cable 81, the person may traverse the steps discussed with reference to FIG. 4 in the opposite direction.

While the invention herein disclosed has been described by means of specific embodiments, numerous modifications and variations could be made thereto by those skilled in the art without departing from the scope and spirit of the invention set forth in the claims.

What is claimed is:

1. A caliper brake of a bicycle comprising:
a first arm;
a cable housing disposed at one end of the first arm;
a second arm pivotably secured to the first arm and comprising a yoke at one end, the yoke including two opposite yoke arms;
a brake cable retaining member for retaining a brake cable passing the cable housing;
a pawl pivotably disposed between the yoke arms and secured to the brake cable retaining member, the pawl including a tooth; and
a spring depressible ratchet including a hook at one end, the ratchet being pivotably disposed between the yoke arms to have the hook to engage with the tooth so that the ratchet is held against rotation to hold the brake cable tight,
wherein in response to rotating the ratchet in a first direction to disengage the hook from the tooth and rotating the pawl in a second direction opposing the first direction, the brake cable is loosened.

2. The caliper brake of claim 1, wherein the other end of the ratchet projects out of the yoke arms.
